(19) United States
(12) Patent Application Publication
(10) Pub. No.: US 2005/0171905 A1
(43) Pub. Date: Aug. 4, 2005

(54) Method and system for conducting a transaction using a proximity device

(76) Inventors: John Wankmueller, Great Neck, NY (US); Gilles Garon, Toronto (CA)

Correspondence Address: BAKER & BOTTS, 30 ROCKEFELLER PLAZA, NEW YORK, NY, 10112, US

(21) Appl. No.: 10/507,867

(22) PCT Filed: Mar. 19, 2003
(86) PCT No.: PCT/US03/08377

Related U.S. Application Data
(60) Provisional application No. 60/365,737, filed on Mar. 19, 2002.

(51) Int. Cl. G06F 17/60

(52) U.S. Cl. 705/41

(57) ABSTRACT

A proximity device transmits a first dynamic authentication value contactlessly to a terminal. The first authentication value is included in a discretionary data field of message data arranged in an ISO Track 1 and/or ISO Track 2 formal Message data is sent from the terminal to an issuer. The issuer separately derives a second authentication value and compares it with the first authentication value.

### PRIORITY AND RELATED APPLICATION

This application claims priority to U.S. provisional application 60/365,737 filed on Mar. 19, 2002, entitled “Proximity Chip Payment Specification,” which is hereby incorporated by reference.

### BACKGROUND OF THE INVENTION

Magnetic stripe cards are often used today for conducting transactions such as debit and credit payments. Such payment cards store information in “tracks”—commonly denoted as “Track 1,” “Track 2,” and “Track 3”—on the magnetic stripe. When such payment cards are swiped through a card reader, data from the tracks is sent over a network to complete a transaction. Such cards typically also include an authentication value printed on the card and an authentication value (which is usually different from the printed value) stored in the magnetic stripe, both of which help to protect against fraud. On a typical MasterCard™ card, the authentication value stored in the magnetic stripe is called CVC1, and the printed authentication value is called CVC2. The printed authentication value does not get transferred to carbon copy paper when a magnetic stripe card is run through an imprinter to make a mechanical copy of the card. Because of this, a duplicate of the card cannot readily be made from the account information transferred to a sales slip (i.e., account number, cardholder name, and expiration date). For telephone or internet purchases where a purchaser is not in the presence of a merchant, the printed value is especially useful to protect against fraud because only the person in possession of the card can verify the printed value to the merchant.

When a transaction involving a magnetic stripe card is conducted using a terminal, the terminal reads the information stored on at least one of the tracks of the credit card. Currently, most terminals read Track 1 and/or Track 2 of the magnetic stripe. The tracks are formatted according to standards promulgated by the International Organization for Standardization (ISO). The relevant ISO standards specify the required data elements to be included on the tracks including, for example, the credit card holder's primary account number, a service or country code, the account holder's name, and a longitudinal redundancy check value. In addition to the foregoing specified data elements, the relevant ISO standards also reserve a data field for use at the discretion of the card issuer. This field is called the “discretionary data field.” Card issuers typically store an authentication value in the discretionary data field. On MasterCard cards, the CVC1 value is stored in the discretionary data field.

Unfortunately, the static nature of a conventional authentication value (whether printed or stored in the magnetic stripe) increases the risk of fraud, because if an unauthorized person obtains the account information and the printed authentication value, that person has all the information required to fabricate a duplicate card.

One approach to reducing the risk of fraud is to use smart cards or integrated circuit cards, which include internal processing functionality, to produce dynamic authentication values. To date, however, smart card technology has used digital signature schemes based on public key cryptography techniques. Such an approach is costly and inconvenient because it requires cards and terminals that must perform cryptographic functions and requires management of public keys. Furthermore, this approach requires the costly modification of and/or addition to the existing payment network infrastructure that currently exists, because the existing infrastructure has been designed for processing magnetic stripe payment cards.

A need therefore exists for better, more cost-effective security for payment card transactions.

### OBJECTS AND SUMMARY OF THE INVENTION

This invention addresses the above-described drawbacks of the prior art by using a dynamic authentication value—preferably generated cryptographically—which is placed in the discretionary data field of a an ISO standard track (preferably, Track 1 and/or Track 2) data field by a proximity device or by a terminal, and is transmitted from the terminal to the issuer of the card or other proximity device being used to conduct a transaction. Along with the dynamic authentication value, the discretionary data field also includes other data to be used by an issuer for verifying the transaction. Preferably, the dynamic authentication value is not the same as the static authentication printed on a magnetic stripe card, but instead, changes with each transaction. As a result, even if an unauthorized person obtains an authentication value used for a particular transaction, the unauthorized person could not use that authentication value for other transactions. Furthermore, because the authentication data is stored in an already-defined field of Track 1 and/or Track 2 in the specified binary coded decimal (BCD) format, the existing payment card network infrastructure can be used with little or no modification.

In accordance with one aspect of the present, a transaction is conducted using a proximity device by the following steps: dynamically generating a first authentication value; transmitting the first authentication value from the proximity device to a terminal; including the first authentication value in a discretionary data field of message data, the message data being arranged in an ISO format; and transmitting the message data from the terminal for verification. Preferably, the message is arranged in an ISO Track 1 or ISO Track 2 format.

In accordance with an additional aspect of the present invention, a transaction is conducted using a proximity device by the following steps: generating a random number; transmitting an authentication command contactlessly from the terminal to the proximity device, the authentication command including the random number; dynamically generating first authentication value using a first authentication key by the proximity device to derive the first authentication value from data comprising at least the random number; transmitting the first authentication value from the proximity device to a terminal; including the first authentication value in a discretionary data field of message data, the message data being arranged in a format including at least one of an ISO Track 1 and an ISO Track 2 format; transmitting the message data from the terminal to an issuer; calculating a second authentication value by an issuer using a second authentication key and the message data; and comparing the second authentication value to the first authentication value by the issuer.

### BRIEF DESCRIPTION OF THE DRAWINGS

Further objects, features, and advantages of the invention will become apparent from the following detailed description taken in conjunction with the accompanying figures showing illustrative embodiments of the invention.

FIG. 1 is a diagram of the interacting components of a system for conducting a transaction using a dynamic authentication value in a discretionary data field according to an exemplary embodiment of the present invention;

FIG. 2 is a diagram illustrating an exemplary layout of data arranged in a Track 1 format;

FIG. 3 is a diagram illustrating an exemplary layout of data arranged in a Track 2 format;

FIG. 4 is a diagram illustrating a layout of the discretionary data field of FIG. 2 in one exemplary embodiment of the present invention;

FIG. 5 is a diagram illustrating a layout of the discretionary data field of FIG. 3 in one exemplary embodiment of the present invention;

FIG. 6 is a flow diagram illustrating a exemplary process whereby a transaction is conducted between a proximity device and an issuer;

FIG. 7 is a flow diagram illustrating a exemplary process whereby an authentication value is calculated by a proximity chip;

FIG. 8 is a flow diagram illustrating a exemplary process whereby a proximity device is verified by an issuer;

FIG. 9 is a diagram illustrating an exemplary computer system for performing the procedures illustrated in FIGS. 1-8; and

FIG. 10 is a block diagram illustrating an exemplary processing section for use in the computer system illustrated in FIG. 9.

While the subject invention will now be described in detail with reference to the figures, it is done so in connection with the illustrative embodiments. It is intended that changes and modifications can be made to the described embodiments without departing from the true scope and spirit of the subject invention as defined by the appended claims.

### DETAILED DESCRIPTION OF THE INVENTION

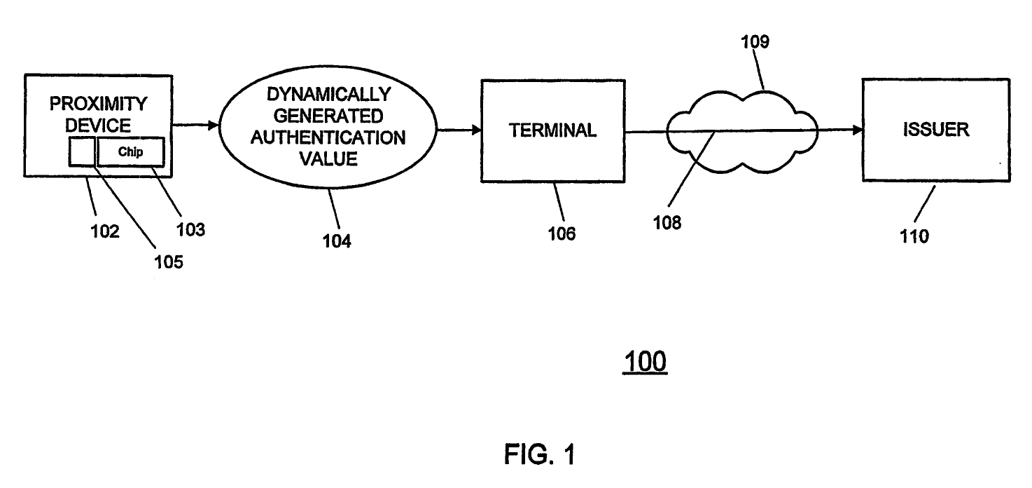

FIG. 1 depicts an exemplary system for conducting transactions according to the present invention. The illustrated system includes a proximity device 102 which includes a proximity chip 103 and contactless communication interface circuitry 105. The proximity device 102 can be in the form of a credit card and can include a magnetic stripe. The proximity device 102 can also take other forms, such as a key fob, and/or can be incorporated into a mobile phone or a watch. The proximity device 102 transmits a dynamically generated authentication value 104 to a terminal 106. The authentication value is typically transmitted via an RF (radio frequency) signal. The authentication value is formatted in a discretionary data field 108 of Track 1 and/or Track 2 and transmitted to an issuer 110, typically through a computer network 109. The formatting can take place in either the proximity device 102 or in the terminal 106.

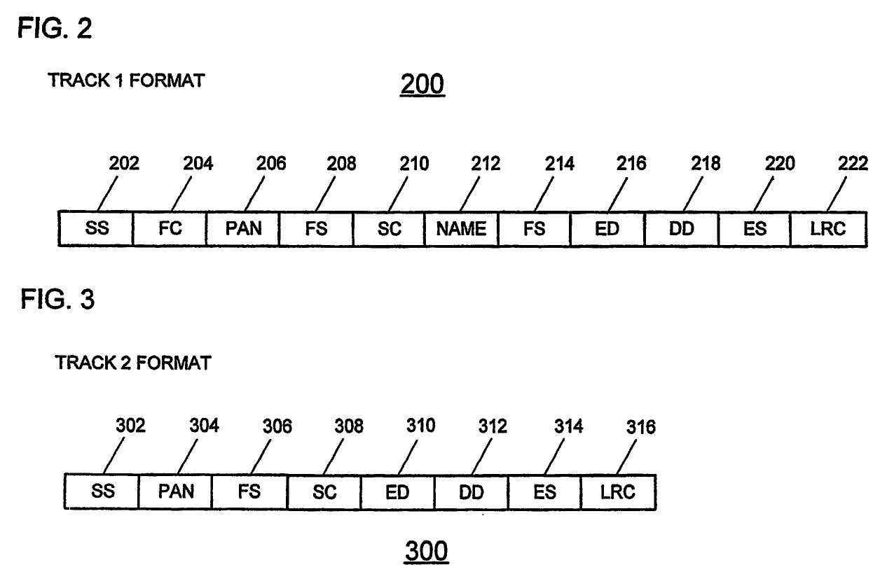

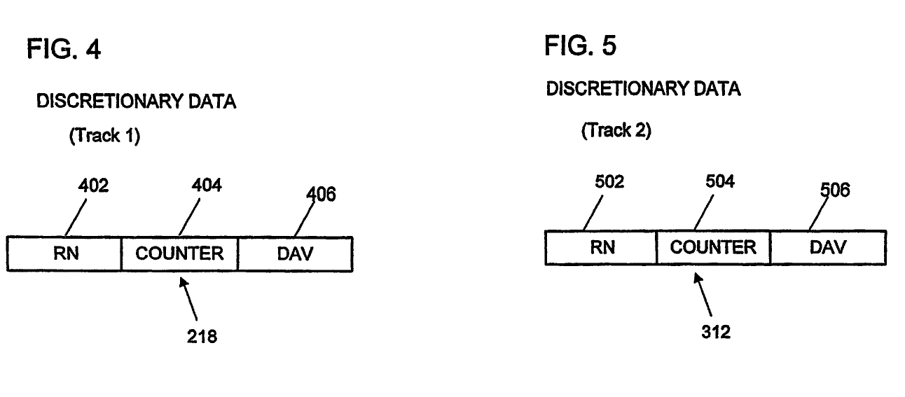

The layout of exemplary data arranged in ISO Track I format is illustrated in FIG. 2. The Track I layout includes a start sentinel 202, followed by a format code 204, followed by a primary account number 206, followed by a field separator 208, followed by a service code 210, followed by the name of the account holder 212, followed by a field separator 214, followed by an expiry date 216, followed by discretionary data 218, followed by an end sentinel 220, and finally by a longitudinal redundancy check 222. The discretionary data 218 can include a random number 402, a counter value 404, and a dynamic authentication value 406, as depicted in FIG. 4.

The layout of exemplary data arranged in ISO Track 2 format is illustrated in FIG. 3. The Track 2 layout includes a start sentinel 302, followed by a primary account number 304, followed by a field separator 306, followed by a service code 308, followed by an expiry date 3 10, followed by discretionary data 312, followed by an end sentinel 314, and finally by a longitudinal redundancy check 316. The discretionary data 312 can include a random number 502, a counter 504, and a dynamic authentication value 506, as depicted in FIG. 5.

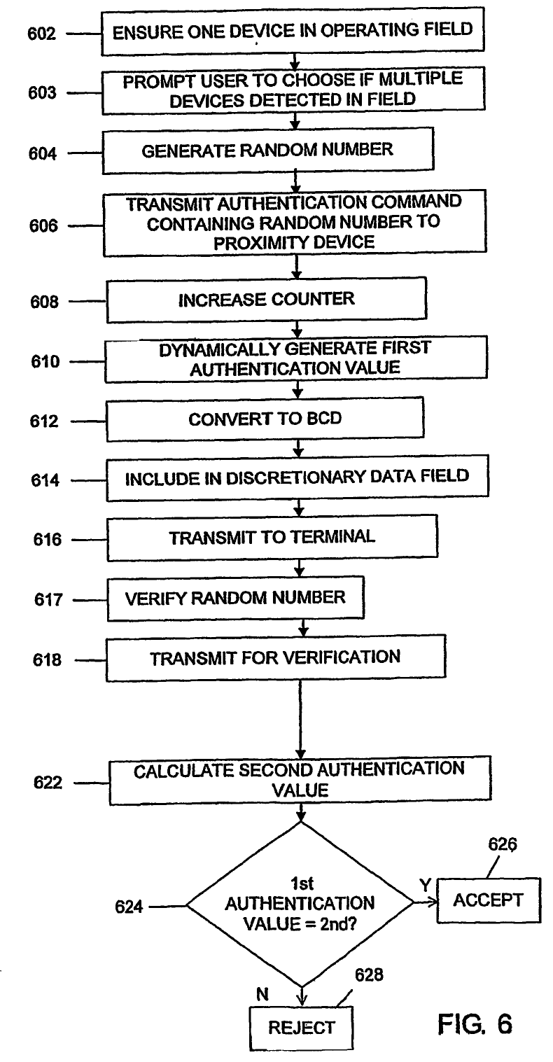

FIG. 6 illustrates an exemplary procedure for conducting a transaction using the system illustrated in FIG. 1. Optionally, the terminal 106 can check to ensure that only one proximity device 102 is within its operating field (step 602). If more than one proximity device 102 is within the operating field, the terminal can prompt the user to choose which proximity device is to be used (step 603). In any case, the terminal 106 or the issuer 110 or the proximity device 102 generates a random number (step 604). The random number can be generated, for example, by a conventional random number generation algorithm or by a hardwired random number generator, and can be in BCD or hexadecimal -(HEX) format. Such random number generation algorithms and hardwired random number generators are well known in the art. The terminal 106 transmits an authentication command containing the random number to the proximity device 102 (step 606). The proximity device 102 contains a proximity chip 103, which maintains a binary counter and increases the counter each time an authentication command is received (step 608). The counter can be in BCD or HEX or binary format. The proximity chip 103 within the proximity device 102 derives a first authentication value using a first authentication key from the random number received (step 610). If a DES (Data Encryption Standard) security infrastructure is being used, the first authentication key is preferably a secret key which is shared with the issuer. If a Public Key Infrastructure (PKI) is being used, the first authentication key is preferably a private key associated with the particular proximity device. In any case, the first authentication key can be stored, for example, in the memory of the proximity chip 103. Contactless communication interface circuitry 105 can be included as part of the proximity chip 103, or it can be separate from the chip. The proximity device 102 includes the first authentication value in a set of message data—optionally, in the discretionary data field of Track 1 and/or Track 2 message data—(step 614) and transmits the message data contactlessly to the terminal 106 (step 616) via the contactless interface 105. The message data also includes the random number and a counter value maintained by the proximity chip 103, or representations thereof. Preferably, the random number or representation thereof in the message data is verified (step 617) at the terminal 106 by comparing it with the random number previously transmitted to the device 102. The representation of the random number can be, for example, the final 3 digits of a longer number previously transmitted to the device. If the first authentication value was not formatted (in step 614) by the proximity device 102 as part of the discretionary data field of Track 1 and/or Track 2 message data, this formatting can be performed by the terminal 106, or by an agent of an issuer 110. The agent can be an issuer application running on a user's computer—e.g. a PC with proximity device reader. In any case, the terminal 106 or the proximity device 102 converts remaining data in HEX or binary format into BCD (step 617). The terminal 106 transmits the data arranged in a Track 2 format 104 for verification (step 618). Verification is typically performed by an issuer 110. Using a second authentication key,—which if DES security is being used, is—presumably the same key as the first authentication key stored in the proximity device 102, the issuer 110 calculates a second authentication value using message data received from the proximity device via the terminal (step 622). If PKI is being used, the second authentication key is presumably the public key associated with the private key of the proximity device. To verify the transaction, the issuer 110 compares the first authentication value with the second authentication value (step 624) and either accepts (step 626) or rejects (step 628) the transaction depending on whether the values match.

The proximity device 102 preferably supports various features, such as an authentication key, a secure messaging key to write to memory areas that are protected, and a manufacturer cryptographic key. The manufacturer cryptographic key allows an issuer to securely load the authentication key, the secure messaging key, and payment related data. Single and double length cryptographic keys should be also supported. The proximity device 102 preferably protects data written to the device memory against deletion or modification, and prohibits the external reading of memory locations containing a cryptographic key. The proximity device 102 should also maintain a binary counter, preferably having at least 15 bits, and should increase the counter (step 608) every time the authenticate command is presented (step 606) to the device 102. The device 102 can implement ISO communication interface Type A, Type B, or both. These well-known interface types are described in ISO/IEC 14443 parts 1-4, which are incorporated herein by reference.

Preferably, the terminal 106 is configured to be capable of reading a magnetic stripe card as well as a proximity device 102. For a device containing both a magnetic stripe and a proximity chip 103, the terminal 106 should first try to perform the transaction using the proximity chip reader, and should use the magnetic stripe if there is an error in communicating with the chip.

At least two commands are typically used to send data from the terminal 106 to the proximity device 102, a select command and an authenticate command. Other commands can also be used, such as the well-known Europay Mastercard Visa (EMV) “get processing options” command. The select command is used to select a proximity chip payment application. The authenticate command initiates computation of the dynamic authentication code within the proximity device. The response to the authenticate command from the device 102 can contain Track 2 formatted data, the device serial number, and transaction flags.

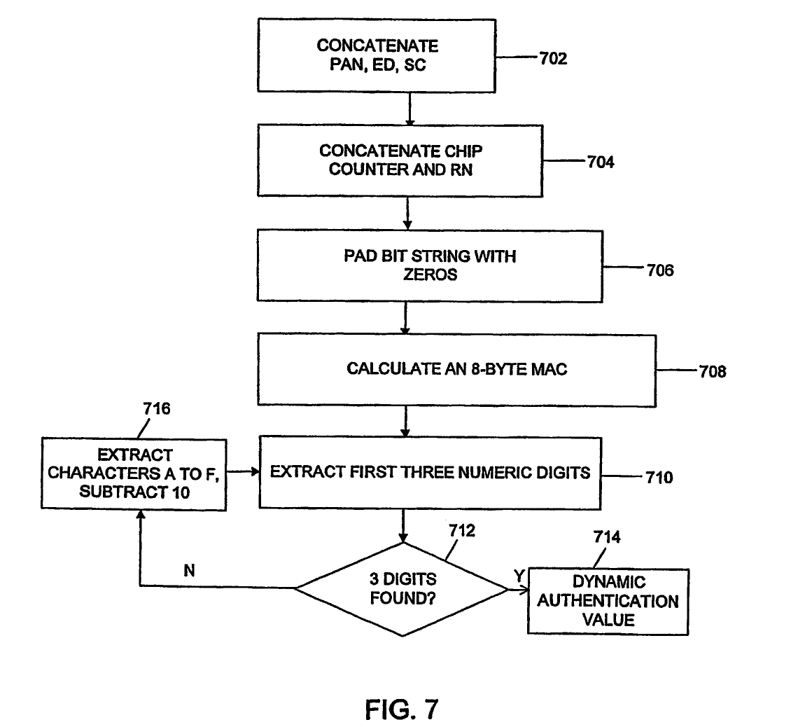

The preferred method of calculating the dynamic authentication value is the well known DES technique. The proximity device 102 preferably calculates the dynamic authentication by the following steps, as depicted in FIG. 7. First, a string of bits is constructed by concatenating, from left to right, the four rightmost bits of each character of the primary account number (up to 16×4=64 bits), the expiry date (4×4=16 bits), and the service code (3×4=12 bits) (step 702). Also concatenated to the bit string are the device proximity chip counter (15 bits) and the 5-digit random number (5×4=20 bits) generated by the terminal 106 (step 704). The bit string is padded with binary zeros to a multiple of 64 bits (typically, to a total of 128 bits) (step 706). For example, the Track 2 “discretionary data” field 312 is 13 BCD when the primary account number is 16 BCD and the DES calculation of the discretionary data field 312 uses all 13 BCD. When the primary account number is less than 16 BCD, the issuer can increase the size of the dynamic authentication value field 506 in the discretionary data field 312 beyond 3 BCD digits. Next, an 8-byte MAC (Message Authentication Code) is calculated using the proximity chip secret authentication key (single or double length) (step 708). The first 3 numeric digits (0-9) from left to right are extracted from the HEX result of the second step above (step 710). If less than 3 digits are found (step 712), characters A to F from left to right are extracted from the result of step 708 and 10 is subtracted to compensate for decimals, until 3 digits are found (step 716). The first three digits found are used as the dynamic authentication value (step 714).

Preferably, the proximity chip 103 converts the proximity chip counter (15-bit) to BCD using the following steps. First, the chip selects the leftmost 3 bits of the counter, adds a zero bit to the left, and converts the result to BCD. Next, the chip selects the next 3 bits of the counter, adds a zero bit to the left and converts the result to BCD. The chip performs the second step an additional 3 times to translate the 15 bit counter to 5 BCD characters. If the above described procedure is used for converting the counter to BCD, each BCD digit will range from 0 to 7. This procedure is beneficial for simplifying the implementation of the hardware and/or software required to convert to BCD in a reduced functionality proximity device. Alternately the counter in the proximity chip 103 can itself be in BCD format, in which case the same format is preferably used in the issuer host system. A BCD-encoded counter makes it possible to increase the size of the maximum counter value to 99,999 in the chip using decimal counting (5 BCD characters, 4 bits per character using only BCD 0-9 characters), although this typically requires more processing logic in the chip.

The proximity device 102 replaces the discretionary data field 312 of Track 2 with the random number (5 BCD) field 502, the proximity chip counter (5 BCD) field 504, and the dynamic authentication value (3 or more BCD) field 506. The proximity device 102 returns the Track 2 data to the terminal 106 in the response to the authenticate command (step 616). The Track 2 data (maximum 19 ‘8 bit’ binary bytes) may be TLV (Tag Length Value) coded (Tag=“57”). The Track 2 data is assembled as follows, using 4-bit BCD values. A start sentinel is followed by the primary account number (up to 16 BCD). This is followed by a field separator, which may be Hex. ‘D’. This is followed by an expiration date, which may be 4 BCD in the format of YYMM. This can be followed by a service code (3 BCD). This may be followed by the dynamic discretionary data (13 or more BCD). The discretionary data can include the random number (5 BCD), followed by the proximity chip counter (5 BCD), followed by the dynamic authentication value. The dynamic authentication value may be 3 BCD when account number is 16 digits, but it can be greater than 3 BCD if account number is less than 16 digits. The discretionary data maybe followed by an end sentinel and a longitudinal redundancy check. Thus, while the discretionary data field used on a traditional magnetic stripe card merely contains enough characters to fill out the maximum record length of Track 2 (40 characters total) and is generally not verified during a transaction, the discretionary data field used with a proximity device in the illustrated example contains a dynamic authentication value in the discretionary data of Track 2 used for authentication of the device.

Some proximity chip manufacturers may not be able to produce a reduced functionality device that supports a DES algorithm. In such cases, a proprietary method can be used to calculate the device dynamic authentication value. Preferably, such a proprietary method should have the following features. A proven proprietary cryptographic algorithm should be used. The proximity chip counter should have a minimum of 15 bits in length. The random number should be 5 digits (5 BCD). The primary account number, the expiry date, the service code, the proximity chip counter, and the random number should be included in the calculation of the dynamic authentication value. The dynamic authentication value should have a minimum of 3 BCD characters. The proximity device 102 should be able to replace the Track 2 discretionary data 306 with the random number, the proximity chip counter, and dynamic authentication value (minimum 3 BCD). The device 102 should return the whole Track 2 data, the proximity device serial number and proximity device transaction flags and other device data. The random number, the proximity device proximity chip counter, and proximity device generated dynamic authentication value should fit in the discretionary data field 312 of the Track 2 data sent to a terminal 106.

Although the preferred method of calculating the dynamic authentication value is the DES method, PKI can also be used.

Each proximity chip authentication key is preferably unique and is preferably derived from a Master Derivation Key protected by the issuer. The Master Derivation Key should be a double length key. Derivation of proximity chip keys should preferably be done in a secure cryptographic device. The encryption function preferably uses the primary account number and the master derivation key to derive the proximity chip authentication key. When a double length proximity chip authentication key is used, the second part of the key should be derived by complementing each bit of the primary account number (1 bits changed to 0, 0 bits changed to 1) before the encryption process.

Even if the issuer uses a proprietary authentication method, the key derivation process should still be similar to the method described above. The device authentication key preferably has a minimum of 48 bits (64 for DES). The bit size doubles for a double length device key.

Upon receipt of an authorization request, the issuer performs the following steps. The issuer determines if the request originates from a proximity device 102, in order to initiate processing specific to proximity devices (step 802). The issuer can do this by a decoding data element (61 position 10) which the terminal would set to a value of ‘7’ to indicate that the request originated from a proximity device that the terminal has read. Alternately, or in addition, the issuer can list into the cardholder database the primary account numbers assigned to the proximity device 102. The issuer host system should, for each proximity device 102, keep track of the proximity chip counter and verify that the proximity chip counter received is the next sequential number (step 804). Verification of the proximity chip counter can be used to prevent transaction replay. Repeated counter values can also indicate that previously used proximity chip Track 2 data has been fraudulently obtained and is now being used by an unauthorized person. Using a proximity chip authentication key, the issuer calculates the proximity device dynamic authentication value as described above using the primary account number, expiry date, service code from the received Track 2, and the authentication data (proximity chip counter, random number) in the Track 2 discretionary field (step 808). The issuer compares the calculated dynamic authentication value to the one in the proximity device Track 2 discretionary data field (step 810) and either accepts (step 812) or rejects (814) the transaction. The issuer can process the authorization as a magnetic stripe authorization when the dynamic authentication value is successfully verified.

Derivation of proximity chip keys and verification of the dynamic authentication value should preferably be done in a secure cryptographic device, such as a host security module.

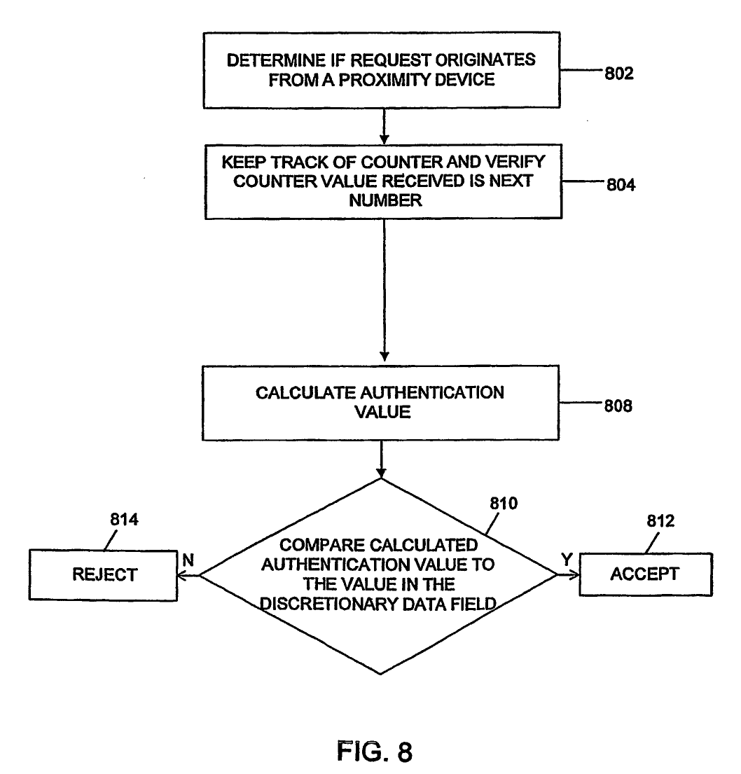

It will be appreciated by those skilled in the art that the methods of FIGS. 1-8 can be implemented on various standard computer platforms operating under the control of suitable software defined by FIGS. 1-8. In some cases, dedicated computer hardware, such as a peripheral card in a conventional personal computer, can enhance the operational efficiency of the above methods.

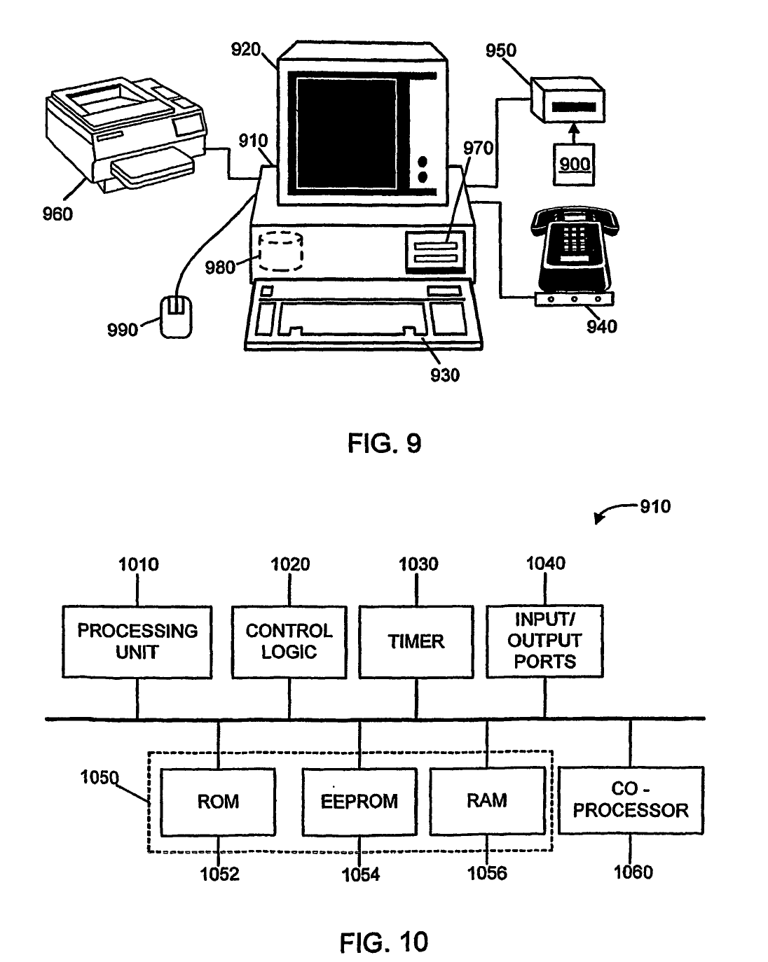

FIGS. 9 and 10 illustrate typical computer hardware suitable for performing the methods of the present invention. Referring to FIG. 9, the computer system includes a processing section 910, a display 920, a keyboard 930, and a communications peripheral device 940 such as a modem. The system typically includes a digital pointer 990 such as a “mouse”, and can also include other input devices such as a card reader 950 for reading an account card 900. In addition, the system can include a printer 960. The computer system typically includes a hard disk drive 980 and one or more additional disk drives 970 which can read and write to computer readable media such as magnetic media (e.g., diskettes or removable hard disks), or optical media (e.g., CD-ROMS or DVDs). The disk drives 970 and 980 are used for storing data and application software.

FIG. 10 is a functional block diagram which further illustrates the processing section 910. The processing section 910 generally includes a processing unit 1010, control logic 1020, and a memory unit 1050. Preferably, the processing section 910 also includes a timer 1030 and input/output ports 1040. The processing section 910 can also include a co-processor 1060, depending on the microprocessor used in the processing unit. Control logic 1020 provides, in conjunction with processing unit 1010, the control necessary to handle communications between memory unit 1050 and input/output ports 1040. Timer 1030 provides a timing reference signal for processing unit 1010 and control logic 1020. Co-processor 1060 provides an enhanced ability to perform complex computations in real time, such as those required by cryptographic algorithms.

Memory unit 1050 can include different types of memory, such as volatile and non-volatile memory and read-only and programmable memory. For example, as shown in FIG. 10, memory unit 1050 can include read-only memory (TOM) 1052, electrically erasable programmable read-only memory (EEPROM) 1054, and random-access memory (RAM) 1056. Various computer processors, memory configurations, data structures and the like can be used to practice the present invention, and the invention is not limited to a specific platform. The steps performed by the processing arrangement are not limited to specific hardware unless the claims so stipulate.

Software defined by FIGS. 1-8 can be written in a wide variety of programming languages, as will be appreciated by those skilled in the art.

The elements of the processing section 910 can be included on a proximity chip 103. A coprocessor 1060 can be used to provide an enhanced ability to perform complex computations in real time, such as those required for DES and PKI encryption. The ROM 1052 preferably comprises a secure ROM which stores the first authentication key.

While there have been described what are believed to be the preferred embodiments of the present invention, those skilled in the art will recognize that other and further changes and modifications may be made thereto without departing from the spirit of the invention, and it is intended to claim all such changes and modifications as fall within the true scope of the invention. For example, specific calculations for the dynamic authentication value have been shown for an embodiment with a Track 2 layout but the invention is also applicable to a Track I layout.

1. A method of conducting a transaction using a proximity device, comprising:
dynamically generating a first authentication value;
transmitting the first authentication value from the proximity device to a terminal;
including the fist authentication value in a discretionary data field of message data, the message data being arranged in an ISO format; and
transmitting the message data from said terminal for verification.

2. The method of claim 1, further comprising:
generating a random number;
transmitting an authentication command contactlessly from said terminal to said proximity device, the authentication command including said random number, the step of dynamically generating the first authentication value comprising using a first authentication key by the proximity device to derive the first authentication value from data comprising at least said random number;
calculating a second authentication value by an issuer using a second authentication key and said message data; and
comparing said second authentication value to said first authentication value by said issuer to verify the transaction.

3. The method of claim 1, wherein the message data is arranged in at least one of an ISO Track 1 format and an ISO Track 2 format.

4. The method of claim 2, further comprising entering user data into the terminal by a user, wherein the step of generating the random number is performed by the terminal based on the user data

5. The method of claim 1, wherein the step of including the first authentication value in the discretionary data field of the message data is performed by said terminal.

6. The method of claim 1, wherein the step of including the first authentication value in the discretionary data field of the message data is performed by said proximity device.

7. The method of claim 1, wherein the step of including the first authentication value in the discretionary data field of the message data is performed by an agent of an issuer.

8. The method of claim 1, wherein said proximity device is in a form of a credit card.

9. The method of claim 8, wherein said proximity device includes a magnetic stripe.

10. The method of claim 9, wherein said proximity device includes a printed authentication value.

11. The method of claim 1, wherein said proximity device is in a form of a key fob.

12. The method of claim 1, wherein said proximity device is included in a mobile telephone.

13. The method of claim 1, wherein said proximity device is included in a watch.

14. The method of claim 2, further comprising:
ensuring by the terminal that said proximity device is an only proximity device within an operating field of said terminal before attempting a transaction.

15. The method of claim 1, further comprising:
detecting multiple proximity devices by the terminal in an operating field of the terminal;
prompting a user to select one of said multiple proximity devices.

16. The method of claim 2, wherein said data comprising at least said random number further comprises at least one of a proximity chip counter, a representation of the random number, and a representation of the proximity chip counter.

17. The method of claim 2, wherein the proximity device has a counter, the method further comprising increasing the counter by said proximity device after a time at which the proximity device is coupled to the terminal.

18. The method of claim 1, further comprising converting the message data to a binary coded decimal format by said terminal before the step of transmitting the message data from said terminal to said issuer.

19. The method of claim 1, wherein the proximity device includes a proximity chip.

20. The method of claim 2, wherein the second authentication key is equal to the first authentication key.

21. The method of claim 2, wherein the first authentication key is a public key infrastructure private key and the second authentication key is a public key infrastructure public key, wherein said public key infrastructure public key is associated with said public key infrastructure private key.

22. The method of claim 2, wherein said message data further includes at least one of a proximity chip counter, the random number, a representation of the random number, and a representation of the proximity chip counter.

23. The method of claim 22, further comprising comparing by said terminal said message data to at least one of the random number and a representation of the random number.

24. The method of claim 22, farther comprising comparing by said issuer said message data to at least one of the random number and a representation of the random number.

25. The method of claim 2, wherein the step of generating the random number is performed by the terminal.

26. A system for conducting a transaction using a proximity device, comprising a processing arrangement configured to perform the steps of:
dynamically generating a first authentication value;
transmitting the first authentication value from the proximity device to a terminal;
including the first authentication value in a discretionary data field of message data, the message data being arranged in an ISO format; and
transmitting the message data from said terminal for verification.

27. A system according to claim 26, wherein the processing arrangement is further configured to perform the steps of:
generating a random number;
transmitting an authentication command contactlessly from said terminal to said proximity device, the authentication command including said random number, the step of dynamically generating the first authentication value comprising using a first authentication key by the proximity device to derive the first authentication value from data comprising at least said random number;
calculating a second authentication value by an issuer using a second authentication key and said message data; and
comparing said second authentication value to said first authentication value by said issuer to verify the transaction.

28. A system according to claim 26, wherein the message data is arranged in at least one of an ISO Track 1 format and an ISO Track 2 format.

29. A system according to claim 27, wherein the terminal is configured to receive user data from a user; the terminal being configured to perform the step of generating the random number based on the user data.

30. A system according to claim 26, wherein the terminal is configured to perform the step of including the first authentication value in the discretionary data field of the message data.

31. A system according to claim 26, wherein the proximity device is configured to perform the step of including the first authentication value in the discretionary data field of the message data.

32. A system according to claim 26, further comprising an agent of an issuer, the agent being configured to perform the step of including the first authentication value in the discretionary data field of the message data.

33. A system according to claim 26, wherein said proximity device is in a form of a credit card.

34. A system according to claim 33, wherein said proximity device includes a magnetic stripe.

35. A system according to claim 34, wherein said proximity device includes a printed authentication value.

36. A system according to claim 26, wherein said proximity device is in a form of a key fob.

37. A system according to claim 26, wherein said proximity device is included in a mobile telephone.

38. A system according to claim 26, wherein said proximity device is included in a watch.

39. A system according to claim 27, wherein the terminal is configured to perform the step of ensuring that said proximity device is an only proximity device within an operating field of said terminal before attempting a transaction.

40. A system according to claim 26, wherein the terminal is configured to perform the steps of:
detecting multiple proximity devices in an operating field of the terminal;
prompting a user to select one of said multiple proximity devices.

41. A system according to claim 27, wherein said data comprising at least said random number further comprises at least one of a proximity chip counter, a representation of the random number, and a representation of the proximity chip counter.

42. A system according to claim 27, wherein the proximity device has a counter, the proximity device is configured to perform the step of increasing the counter by said proximity device after a time at which the proximity device is coupled to the terminal.

43. A system according to claim 26, wherein the terminal is configured to perform the step of converting the message data to a binary coded decimal format before the step of transmitting the message data from said terminal to said issuer.

44. A system according to claim 26, wherein the proximity device includes a proximity chip.

45. A system according to claim 27, wherein the second authentication key is equal to the first authentication key.

46. A system according to claim 27, wherein the first authentication key is a public key infrastructure private key and the second authentication key is a public key infrastructure public key, wherein said public key infrastructure public key is associated with said public key infrastructure private key.

47. A system according to claim 27, wherein said message data further includes at least one of a proximity chip counter, the random number, a representation of the random number, and a representation of the proximity chip counter.

48. A system according to claim 47, wherein the terminal is configured to perform the step of comparing said message data to at least one of the random number and a representation of the random number.

49. A system according to claim 47, wherein the issuer is configured to perform the step of comparing said message data to at least one of the random number and a representation of the random number.

50. A system according to claim 27, wherein the terminal is configured to perform the step of generating the random number.

51. A computer-readable medium for conducting a transaction using a proximity device, the computer-readable medium having a set of instructions operable to direct a processor to perform the steps of:
dynamically generating a first authentication value;
transmitting the first authentication value from the proximity device to a terminal;
including the first authentication value in a discretionary data field of message data, the message data being arranged in an ISO format; and
transmitting the message data from said terminal for verification.

52. A computer-readable medium according to claim 51, wherein the set of instructions is further operable to direct the processor to perform the steps of:
generating a random number;
transmitting an authentication command contactlessly from said terminal to said proximity device, the authentication command including said random number, the step of dynamically generating the first authentication value comprising using a first authentication key by the proximity device to derive the first authentication value from data comprising at least said random number;
calculating a second authentication value by an issuer using a second authentication key and said message data; and
comparing said second authentication value to said first authentication value by said issuer to verify the transaction.

53. A computer-readable medium according to claim 51, wherein the message data is arranged in at least one of an ISO Track 1 format and an ISO Track 2 format.

54. A computer-readable medium according to claim 52, wherein the computer-readable medium is further operable to direct the terminal to receive user data from a user, the step of generating the random number being performed by the terminal based on the user data.

55. A computer-readable medium according to claim 51, wherein the step of including the first authentication value in the discretionary data field of the message data is performed by said terminal.

56. A computer-readable medium according to claim 51, wherein the step of including the first authentication value in the discretionary data field of the message data is performed by said proximity device.

57. A computer-readable medium according to claim 51, wherein the step of including the first authentication value in the discretionary data field of the message data is performed by an agent of an issuer.

58. A computer-readable medium according to claim 51, wherein said proximity device is in a form of a credit card.

59. A computer-readable medium according to claim 58, wherein said proximity device includes a magnetic stripe.

60. A computer-readable medium according to claim 59, wherein said proximity device includes a printed authentication value.

61. A computer-readable medium according to claim 51, wherein said proximity device is in a form of a key fob.

62. A computer-readable medium according to claim 51, wherein said proximity device is included in a mobile telephone.

63. A computer-readable medium according to claim 51, wherein said proximity device is included in a watch.

64. A computer-readable medium according to claim 51, wherein the set of instructions is further operable to direct the processor to perform the step of ensuring by the terminal that said proximity device is an only proximity device within an operating field of said terminal before attempting a transaction.

65. A computer-readable medium according to claim 52, wherein the set of instructions is further operable to direct the processor to perform the steps of:
detecting multiple proximity devices by the terminal in an operating field of the terminal;
prompting a user to select one of said multiple proximity devices.

66. A computer-readable medium according to claim 52, wherein said data comprising at least said random number further comprises at least one of a proximity chip counter, a representation of the random number, and a representation of the proximity chip counter.

67. A computer-readable medium according to claim 52, wherein the proximity device has a counter, the set of instructions is further operable to direct the processor to perform the step of increasing the counter by said proximity device after a time at which the proximity device is coupled to the terminal.

68. A computer-readable medium according to claim 51, wherein the set of instructions is further operable to direct the processor to perform the step of converting the message data to a binary coded decimal format by said terminal before the step of transmitting the message data from said terminal to said issuer.

69. A computer-readable medium according to claim 51, wherein the proximity device includes a proximity chip.

70. A computer-readable medium according to claim 52, wherein the second authentication key is equal to the first authentication key.

71. A computer-readable medium according to claim 52, wherein the first authentication key is a public key infrastructure private key and the second authentication key is a public key infrastructure public key, wherein said public key infrastructure public key is associated with said public key infrastructure private key.

72. A computer-readable medium according to claim 52, wherein said message data further includes at least one of a proximity chip counter, the random number, a representation of the random number, and a representation of the proximity chip counter.

73. A computer-readable medium according to claim 72, wherein the set of instructions is further operable to direct the terminal to perform the step of comparing said message data to at least one of the random number and a representation of the random number.

74. A computer-readable medium according to claim 72, wherein the set of instructions is further operable to direct an agent of the issuer to perform the step of comparing said message data to at least one of the random number and a representation of the random number.

75. A computer-readable medium according to claim 52, wherein the step of generating the random number is performed by the terminal.
